(19) United States
(12) Patent Application Publication
(10) Pub. No.: US 2020/0073701 A1
(43) Pub. Date: Mar. 5, 2020

(54) DATA STORAGE DEVICE, OPERATION METHOD THEREOF AND STORAGE SYSTEM HAVING THE SAME

(71) Applicant: SK hynix Inc., Gyeonggi-do (KR)

(72) Inventor: Jeen PARK, Gyeonggi-do (KR)

(21) Appl. No.: 16/217,394

(22) Filed: Dec. 12, 2018

(30) Foreign Application Priority Data
Aug. 30, 2018 (KR) 10-2018-0102982

(51) Int. Cl. G06F 9/48; G06F 9/4401; G06F 13/24; G06F 11/07

(52) U.S. Cl. CPC G06F 9/4812; G06F 9/4418; G06F 2201/81; G06F 11/0757; G06F 2213/24; G06F 13/24

(57) ABSTRACT

A data storage device may include: a storage; and a controller configured to control data input/output on the storage according to a request transferred from a host device, and provide at least some of read data to the host device before a preset read timeout threshold time is completely consumed, when an interrupt event occurs before a processing of a read request of the host device is completed.

### CROSS-REFERENCE TO RELATED APPLICATION

The present application claims priority under 35 U.S.C. § 119(a) to Korean application number 10-2018-0102982, filed on Aug. 30, 2018, in the Korean Intellectual Property Office, which is incorporated herein by reference in its entirety.

### BACKGROUND

### 1. Technical Field

Various embodiments of the present invention generally relate to a semiconductor integrated device. Particularly, the embodiments relate to a data storage device, an operation method thereof and a storage system including the same.

### 2. Related Art

A storage device is connected to a host device and performs a data input/output operation according to a request of the host device. The storage device may use various storage media to store data.

The storage device may include a device for storing data in a magnetic disk such as a hard disk drive (HDD) and a device for storing data in a semiconductor memory device such as a solid state drive (SSD) or memory card, or specifically a nonvolatile memory.

A flash memory-based storage medium has advantages such as a high capacity, nonvolatile property, low unit price, low power consumption and high data processing speed.

The performance of a storage medium may depend on whether the storage medium can reliably process data while providing a high capacity.

### SUMMARY

In an embodiment, a data storage device may include: a storage; and a controller configured to control data input/output on the storage according to a request transferred from a host device, and provide at least some of read data to the host device before a preset read timeout threshold time is completely consumed, when an interrupt event occurs before a processing of a read request of the host device is completed.

In an embodiment, a data storage device may include: a storage; and a controller configured to control data input/output on the storage according to a request transferred from a host device, and provide some of data read in response to a read request of the host device to the host device while a background operation is processed.

In an embodiment, a data storage device may include: a storage; and a controller configured to control data input/output on the storage according to a request transferred from a host device, buffer at least some of read data into a buffer memory in response to a read request of the host device, and output at least some of the buffered read data to the host device while an interrupt event is processed, when the interrupt event occurs before a processing of the read request of the host device is completed.

In an embodiment, there is provided an operation method of a data storage device which includes a storage and a controller configured to control data input/output on the storage according to a request transferred from a host device. The operation method may include the steps of: receiving, by the controller, a read request from the host device, and reading data; recognizing an occurrence of interrupt event, before the reading of data is completed; and providing at least some of the read data to the host device before a preset read timeout threshold time is completely consumed.

In an embodiment, a storage system may include: a host device; and a data storage device comprising a storage and a controller configured to control data input/output on the storage according to a request transferred from the host device, wherein when an interrupt event occurs before a processing of a read request of the host device is completed, the controller provides at least some of read data to the host before a preset read timeout threshold time is completely consumed.

In an embodiment, a data storage device may include: a storage; and a controller configured to output, to a host in response to a request of the host, at least a piece of so far read data within a read timeout duration while processing an interrupt event and suspending a read operation related to the so far read data.

### BRIEF DESCRIPTION OF THE DRAWINGS

FIG. 1 is a configuration diagram illustrating a data storage device in accordance with an embodiment.

FIG. 2 is a configuration diagram illustrating a controller in accordance with the present embodiment.

FIG. 3 is a configuration diagram illustrating a host interface layer in accordance with the present embodiment.

FIG. 4 is a flowchart for describing an operation method of a data storage device in accordance with an embodiment.

FIG. 5 is a timing diagram for describing the operation method of the data storage device in accordance with the present embodiment.

FIG. 6 is a flowchart illustrating an operation method of a data storage device in accordance with an embodiment.

FIG. 7 is a timing diagram for describing the operation method of the data storage device in accordance with the present embodiment.

FIG. 8 is a diagram illustrating a data storage system in accordance with an embodiment.

FIG. 9 and FIG. 10 are diagrams illustrating a data processing system in accordance with an embodiment.

FIG. 11 is a diagram illustrating a network system including a data storage device in accordance with an embodiment.

FIG. 12 is a block diagram illustrating a nonvolatile memory device included in a data storage device in accordance with an embodiment.

### DETAILED DESCRIPTION

The technical spirit of the present disclosure may be changed in various manners, and may be implemented as embodiments having various aspects. Hereinafter, the present disclosure will be described by way of some embodiments so that those skilled in the art can easily practice the embodiments of the present disclosure. It is noted that reference to “an embodiment” does not necessarily mean only one embodiment, and different references to “an embodiment” are not necessarily to the same embodiment(s).

It will be understood that, although the terms “first” and/or “second” may be used herein to describe various elements, these elements should not be limited by these terms. These terms are only used to distinguish one element, from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to” or “directly adjacent to” should be construed in the same way.

The terminology used herein is for the purpose of describing particular embodiments only and is not intended to be limiting. In the present disclosure, the singular forms are intended to include the plural forms as well, unless the context clearly indicates otherwise. It will be further understood that the terms “comprise”, “include”, “have”, etc, when used in this specification, specify the presence of stated features, numbers, steps, operations, elements, components, and/or combinations of them but do not preclude the presence or addition of one or more other features, numbers, steps, operations, elements, components, and/or combinations thereof.

The above-described exemplary embodiments are merely for the purpose of understanding the technical spirit of the present disclosure and the scope of the present disclosure should not be limited to the above-described exemplary embodiments. It will be obvious to those skilled in the art to which the present disclosure pertains that other modifications based on the technical spirit of the present disclosure may be made in addition to the above-described exemplary embodiments.

Unless otherwise defined, all terms including technical and scientific terms used herein have the same meaning as commonly understood by one of ordinary skill in the art to which the present disclosure belongs. Unless otherwise defined in the present disclosure, the terms should not be construed as being ideal or excessively formal.

Hereinafter, a data storage device, an operation method thereof and a storage system including the same according to the present disclosure will be described below with reference to the accompanying drawings through exemplary embodiments.

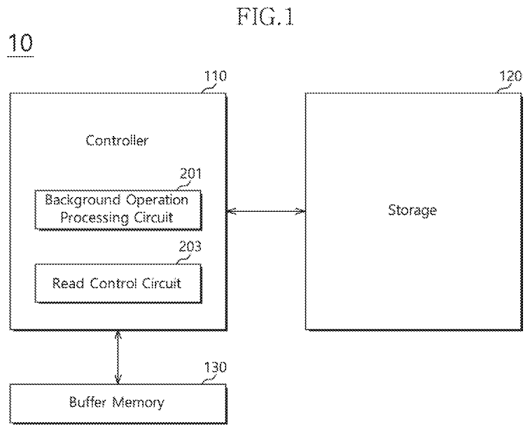

FIG. 1 is a configuration diagram illustrating a data storage device 10 in accordance with an embodiment.

Referring to FIG. 1, the data storage device 10 in accordance with the present embodiment may include a controller 10, a storage 120 and a buffer memory 130.

The controller 110 may control the storage 120 in response to a request of a host device. For example, the controller 110 may control the storage 120 to program data thereto, according to a program (write) request of the host device. Also, the controller 110 may provide data written in the storage 120 to the host device in response to a read request of the host device. In an embodiment, the controller 110 may store a command or request transferred from the host device in a queue, and process the command according to a result obtained by scheduling the command.

The storage 120 may write data or output data written therein according to control of the controller 110. The storage 120 may be configured as a volatile or nonvolatile memory device. In an embodiment, the storage 120 may be implemented with a memory device selected from various nonvolatile memory devices such as an EEPROM (Electrically Erasable and Programmable ROM), NAND flash memory, NOR flash memory, PRAM (Phase-Change RAM), ReRAM (Resistive RAM), FRAM (Ferroelectric RAM) and STT-MRAM (Spin Torque Transfer Magnetic RAM). The storage 120 may include one or more dies. Each of the dies may include a plurality of planes. Each of the planes may include one or more memory blocks, and each of the memory blocks may have a hierarchy structure that includes one or more pages each including a plurality of memory cells. Read and write (program) operations may be performed on a page basis, for example, and an erase operation may be performed in a block basis, for example. In order to improve data input/output speed, the processing component of read or written data may be determined according to the fabrication purpose of the data storage device 10. Furthermore, the storage 120 may include single-level cells each configured to store one-bit data therein or multi-level cells each configured to store multi-bit data therein.

The buffer memory 130 may serve as a space for temporarily storing data when the data storage device 10 performs a series of operations of writing or reading data while interworking with the host device. FIG. 1 illustrates that the buffer memory 130 is positioned outside the controller 110, but the buffer memory 130 may be positioned inside or outside the controller 110.

In an embodiment, the controller 110 may include a background operation processing circuit 201 and a read control circuit 203.

The background operation processing circuit 201 may perform an operation of processing an internal command which is generated by the controller 110 itself, instead of a request of the host device. In an embodiment, the background operation may indicate an operation for efficiently managing the storage 120 according to the available capacity of the storage 120 or the wear level or disturbance of the storage 120. The background operation may include a garbage collection operation, a read reclaim operation and the like.

The garbage collection operation may indicate an operation of securing free blocks by retrieving valid data distributed in a plurality of source blocks, collecting the valid data in any one victim free block, deleting data of the source blocks, and updating a map table.

The read reclaim operation may indicate an operation of transferring data of a deteriorating source block to a new destination block, deleting the data of the source block, and updating a map table, thereby preventing an occurrence of uncorrectable errors caused by the deterioration of the data.

The priority of the background operation may vary according to the internal situation of the storage 120, for example, the number of empty blocks or the retention levels of the respective blocks in the storage 120.

The background operation processing circuit 201 may process a background operation according to an internal command, based on a preset priority. An internal command, that is issued while a host command is processed and has a higher priority than the host command, may be processed as an interrupt event while suspending the processing of the host command.

The read control circuit 203 may read data by accessing a specific region of the storage 120 in response to a read request of the host device, and provide the read data to the host device through the buffer memory 130.

When an interrupt event occurs before the processing of the read request of the host device is completed, the read control circuit 203 may provide at least some of the read data to the host before a preset read timeout threshold time is completely consumed. The interrupt event may have a higher priority than the read request of the host, and include garbage collection or read reclaim, for example.

From another point of view, the read control circuit 203 may output some of data to the host device during a background operation of the controller 110, the data being read in response to a read request of the host device.

From another point of view, the read control circuit 203 may buffer at least some of read data into the buffer memory 130 in response to a read request of the host device. Then, when an interrupt event occurs before the processing of the read request of the host device is completed, at least some of the read data buffered in the buffer memory 130 may be outputted to the host device while the interrupt event is processed. At this time, at least some of the buffered read data may be outputted independently of the processing of the interrupt event, without suspending the processing of the interrupt event. In an embodiment, at least some of the buffered read data may be outputted to the host device, while the processing of the interrupt event is temporarily suspended. Then, the processing of the interrupt event may be resumed. In an embodiment, the processing of the interrupt event may be a group of a plurality of sub operations, and the processing of the interrupt event may be temporarily suspended between the sub operations.

Within the read timeout threshold time, at least a piece of read data is supposed to be outputted in response to a read request after the host device transfers the read request. That is, the read timeout threshold time may represent a time interval between neighboring outputs of pieces of the read data. When an interrupt event for a background operation or the like occurs after the read request of the host device, the processing of the read request of the host device may be suspended. At this time, when the time required for processing the interrupt event is longer than the read timeout threshold time, a response to the read request cannot be transferred to the host device, until the interrupt event is completely processed. In this case, the host device may recognize that a timeout error occurred in the data storage device 10.

In the present embodiment, even while the interrupt event is processed, at least some of the read data can be transferred to the host device, before the preset read timeout threshold time is completely consumed. Thus, even while the interrupt event is processed, the host device may recognize that the host command is being processed, which makes it possible to prevent a timeout error.

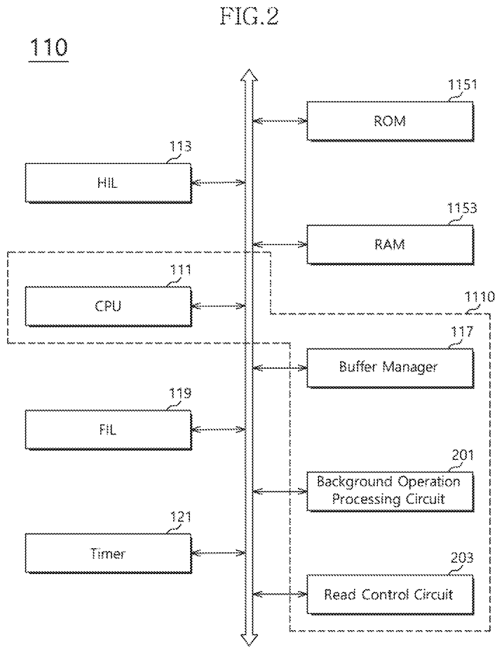

FIG. 2 is a configuration diagram illustrating the controller 110 in accordance with the present embodiment.

Referring to FIG. 2, the controller 110 in accordance with the present embodiment may include a CPU 111, a host interface layer (HIL) 113, a ROM 1151, a RAM 1153, a buffer manager 117, a flash interface layer (FIL) 119, a timer 121, the background operation processing circuit 201 and the read control circuit 203.

The CPU 111 may be configured to transfer various pieces of control information to the HIL 113, the RAM 1153 and the FIL 119, the various pieces of control information being required for reading or writing data from or to the storage 120. In an embodiment, the CPU 111 may operate according to firmware provided for various operations of the data storage device 10. In an embodiment, the CPU 111 may perform a function of a flash translation layer (FTL) for performing garbage collection, address mapping or wear leveling to manage the storage 120 and a function of detecting and correcting an error of data read from the storage 120.

The HIL 113 may control the host device and the controller 110 to interface with each other. The HIL 113 may receive a command and clock signal from the host device, and provide a communication channel for controlling data input/output. The command provided from the host device may be stored and decoded in the HIL 113, and then provided to the CPU 111.

The HIL 113 may provide a physical connection between the host device and the data storage device 10. Furthermore, the HIL 113 may provide an interface with the data storage device 10 according to the bus format of the host device. The bus format of the host device may include one or more of standard interface protocols such as secure digital, USB (Universal Serial Bus), MMC (Multi-Media Card), eMMC (Embedded MMC), PCMCIA (Personal Computer Memory Card International Association), PATA (Parallel Advanced Technology Attachment), SATA (Serial Advanced Technology Attachment), SCSI (Small Computer System Interface), SAS (Serial Attached SCSI), PCI (Peripheral Component Interconnection), PCI-E (PCI Express) and UFS (Universal Flash Storage).

The ROM 1151 may store program codes required for an operation of the controller 110, for example, firmware or software. Furthermore, the ROM 1151 may store code data used by the program codes.

The RAM 1153 may store data required for an operation of the controller 110 or data generated by the controller 110.

The buffer manager 117 may be configured to manage the use statuses of the buffer memory 130.

The FIL 119 may provide a communication channel for transmitting/receiving signals between the controller 110 and the storage 120. The FIL 119 may write data to the storage 120 according to control of the CPU 111, the data being temporarily stored in the buffer memory 130. Furthermore, the FIL 119 may transfer data read from the storage 120 to the buffer memory 130 to temporarily store the data.

The timer 121 may be configured to measure the processing time of the controller 110.

The background operation processing circuit 201 may perform an operation of processing an internal command which is generated by the controller 110 itself, instead of a request of the host device. In an embodiment, the background operation may include a garbage collection operation, a read reclaim operation and the like.

The background operation processing circuit 201 may process a background operation according to an internal command, based on a preset priority. An internal command, that is issued while a host command is processed and has a higher priority than the host command, may be processed as an interrupt event while suspending the processing of the host command. The priority of the background operation may be varied according to the internal situation of the storage 120, for example, the number of empty blocks in the storage 120 or the retention levels of the respective blocks.

The read control circuit 203 may read data by accessing a specific region of the storage 120 in response to a read request of the host device, and provide read data to the host device through the buffer memory 130.

When an interrupt event occurs before the read request of the host device is completed, the read control circuit 203 may provide at least some of the read data to the host before the preset read timeout threshold time is completely consumed.

From another point of view, the read control circuit 203 may output some of data to the host device during a background operation of the controller 110, the data being read in response to a read request of the host device.

From another point of view, the read control circuit 203 may buffer at least some of read data into the buffer memory 130 in response to a read request of the host device. Then, when an interrupt event occurs before the processing of the read request of the host device is completed, at least some of the read data buffered in the buffer memory 130 may be outputted to the host device while the interrupt event is processed. At this time, at least some of the buffered read data may be outputted independently of the processing of the interrupt event, without suspending the processing of the interrupt event. In an embodiment, at least some of the buffered read data may be outputted to the host device, while the processing of the interrupt event is temporarily suspended. Then, the processing of the interrupt event may be resumed. In an embodiment, the processing of the interrupt event may be a group of a plurality of sub operations, and the processing of the interrupt event may be temporarily suspended between the sub operations.

In the controller 110 illustrated in FIG. 2, the CPU 111, the buffer manager 117, the background operation processing circuit 201 and the read control circuit 203 may be integrated to perform the function of the FTL 1110.

The FTL 1110 may control the controller 110 to perform a garbage collection operation, address mapping operation or wear leveling operation for managing the storage 120.

Therefore, write data transferred from the host device may be transferred to the buffer memory 130 according to control of the HIL 113. The FTL 1110 may determine where to store write data in the storage 120, map the logical address of the write data to a physical address, and reflect the mapping result into the mapping table. When the mapping is completed, the data which are temporarily stored in the buffer memory 130 may be stored in the determined physical position of the storage 120 according to control of the FIL 119.

The data read from the storage 120 may be transferred to the buffer memory 130 according to control of the FIL 119. The HIL 113 may provide the host device with the read data transferred to the buffer memory 130.

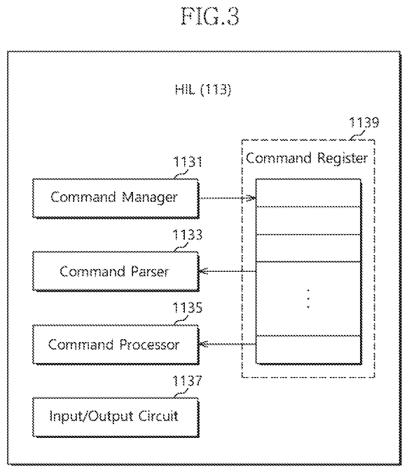

FIG. 3 is a configuration diagram illustrating the HIL 113 in accordance with the present embodiment.

Referring to FIG. 3, the HIL 113 may include a command manager 1131, a command parser 1133, a command processor 1135, an input/output circuit 1137 and a command register 1139.

As a command is provided from the host device, the command manager 1131 may assign an empty space of the command register 1139 to store the command.

The command parser 1133 may parse the command provided from the host.

The command processor 1135 may process the command parsed through the command parser 1133 in preset order.

The input/output circuit 1137 may transfer write data of the host device to the buffer memory 130 to store the write data, and transfer data read from the storage 120 to the host device through the buffer memory 130.

The command register 1139 may serve as a queue for storing commands managed by the command manager 1131, and the command processed by the command processor 1135 may be deleted from the command register 1139.

In response to a read request of the host device, at least some of read data may be buffered into the buffer memory 130. When an interrupt event occurs before the read request of the host device is completed, the input/output circuit 1137 of the HIL 113 may provide at least some of the buffered read data to the host device, while the interrupt event is processed by the FTL 1110.

Therefore, since the host device can receive the read data corresponding to the read request even while the interrupt event is processed, the host device can recognize that the read request s being normally processed without a timeout error.

FIG. 4 is a flowchart for describing an operation method of the data storage device 10 in accordance with an embodiment.

A read request of the host device may be provided to the FTL 1110 through the HIL 113 at steps S101 and S103, respectively. That is, the HIL 113 may receive the read request from the host device at step S101, store and parse the read request, and transfer the read request to the FTL 1110 at step S103.

After the read request is transferred to the FTL 1110, an interrupt event may occur at step S105. The FTL 1110 may determine a processing order based on the priority of the interrupt event and the priority of the host read request.

When the priority of the interrupt event is higher, the FTL 1110 may access the storage 120 through the FIL 119 to read a preset size of unit data from the storage 120 in response to the read request, and buffer the read data in the buffer memory 130, at step S107. In an embodiment, the preset size may correspond to [sector size*N] Byte. For example, the sector size may be set to 512 Byte, and the size of the unit data may be set to 4 KByte.

After buffering the unit data, the FTL 1110 may process the interrupt event at step S109.

While the interrupt event is processed in the FTL 1110, the HIL 113 may monitor whether the read timeout threshold time corresponding to the read request of the host device becomes completely consumed. For example, the HIL 113 may monitor an elapsed time T since the read request is received or may start to count the read timeout threshold time, in order to determine whether the elapsed time T reaches a time point between a timeout critical time Tth1 and the end of the read timeout threshold time Tth2 (Tth1<T<Tth2), at step S111. When it is determined that the elapsed time T reaches a time point between a timeout critical time Tth1 and the end of the read timeout threshold time Tth2 (Tth1<T<Tth2) (“Y” at step S111), the HIL 113 may output sub unit data to the host device, the sub unit data corresponding to at least some pieces of the unit data (i.e., a part of the read data) buffered in the buffer memory 130, at step S113. Therefore, while processing the interrupt event over the read request, the FTL 1110 can respond to the read request of the host device, thereby preventing a timeout error.

The FTL 1110 may check whether the processing of the interrupt event is completed, at step S115. When the processing of the interrupt event is completed (“Y” at step S115), the FTL 1110 may inform the HIL 113 that the processing of the interrupt event is completed, in order to control the HIL 113 not to output the sub unit data anymore, at step S117. Then, the FTL 1110 may read remaining pieces of data from the storage 120 through the FIL 119 and store the read data in the buffer memory 130, at step S119. Then, the FTL 1110 may inform the HIL 113 that the read operation is completed, at step S121. Therefore, the HIL 113 may provide the remaining pieces of read data stored in the buffer memory 130 to the host device at step S123.

When the processing of the interrupt event is not completed (“N” at step S115), the FTL 1110 may check whether the sub unit data buffered at step S107 remains, at step S125. When the buffered sub unit data remains (“Y” at step S125), the FTL 1110 may process the interrupt event at step S109. On the other hand, when the buffered unit data do not remain (“N” at step S125), the procedure may return to step S107. When the read timeout threshold time is completely consumed a plurality of times while the interrupt event is processed, the sub unit data may be outputted a plurality of times. In this case, no more sub unit data may remain in the buffer memory 130. Therefore, when all of the sub unit data are outputted before the processing of the interrupt event is completed, the processing of the interrupt event may be temporarily suspended, and another sub unit data may be buffered to provide against a timeout.

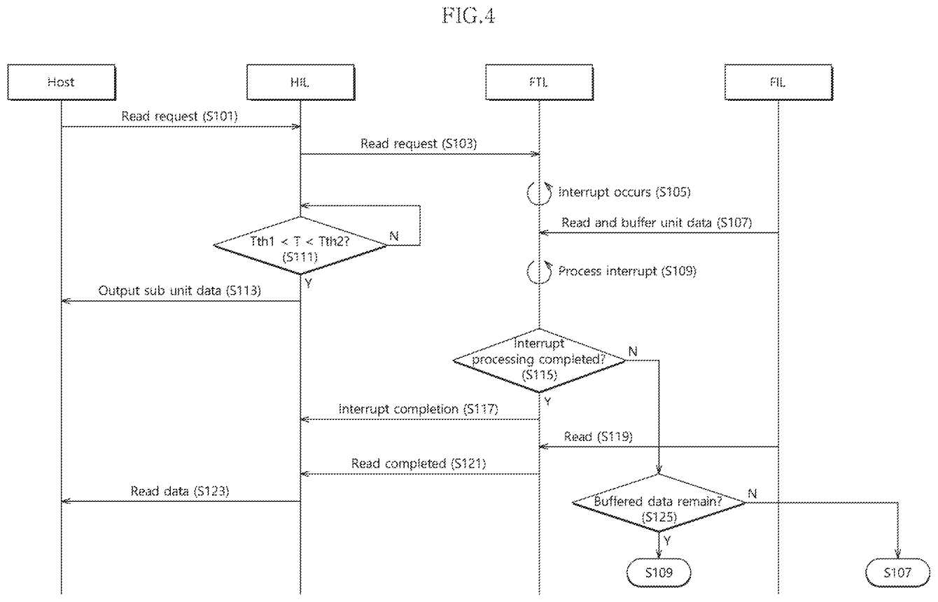

FIG. 5 is a timing diagram for describing the operation method of the data storage device 10 in accordance with the present embodiment.

FIG. 5 shows that, while an interrupt enable signal INTR_EN is enabled after a host read request, sub unit data SD1 to SDn are outputted.

The sub unit data SD1 to SDn may start to be outputted between the timeout critical time Tth1 and the end of the read timeout threshold time Tth2.

In the operation method described with reference to FIGS. 4 and 5, the case in which the subject FTL to process an interrupt event and the subject HIL to output buffered read data are independent of each other has been taken as an example for description. However, the present embodiment is not limited thereto.

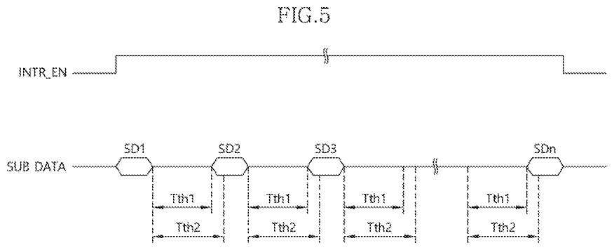

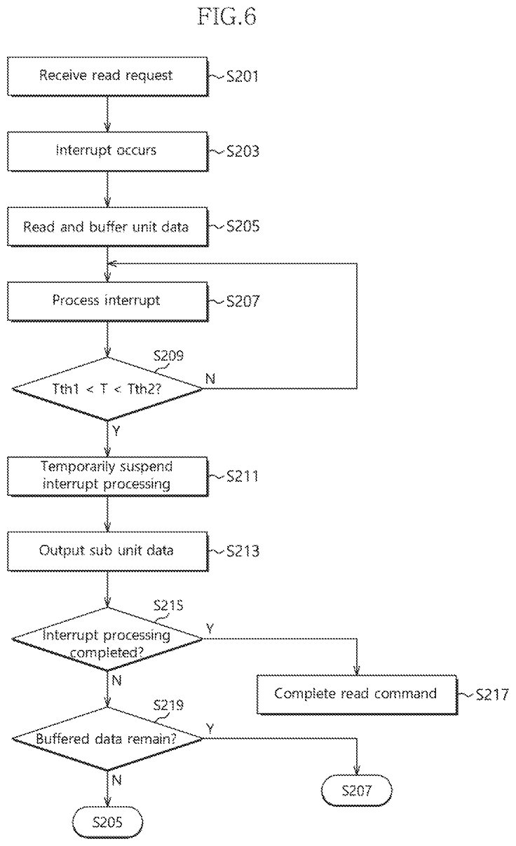

That is, the present embodiment can be applied to the case in which the FTL 1110 serves as the subject to process an interrupt event as well as the subject to output buffered read data, as illustrated in FIGS. 6 and 7.

FIG. 6 is a flowchart illustrating an operation method of the data storage device 10 in accordance with an embodiment.

Referring to FIG. 6, a read request of the host device may be provided to the H L 1110 through the HIL 113 at step S201.

After the read request is transferred to the H L 1110, an interrupt event may occur at step S203.

The FTL 1110 may determine a processing order based on the priority of the interrupt event and the priority of the host read request. When the priority of the interrupt event is higher, the FTL 1110 may read a preset size of unit data from the storage 120 by accessing the storage 120 through the FIL 119 in response to the read request, and buffer the read data into the buffer memory 130, at step S205. In an embodiment, the preset size may correspond to [sector size*N] Byte. For example, the sector size may be set to 512 Byte, and the size of the unit data may be set to 4 KByte.

After buffering the unit data, the FTL 1110 may process the interrupt event at step S207.

While the interrupt event is processed, the FTL 1110 may monitor an elapsed time T since the read request is received or may start to count the read timeout threshold time, and may determine whether the elapsed time T reaches a time point between the timeout critical time Tth1 and the end of the read timeout threshold time Tth2 (Tth1<T<Tth2), at step S209. When it is determined that the elapsed time T does not reach a time point between the timeout critical time Tth1 and the end of the read timeout threshold time Tth2 (“N” at step S209) the operation goes back to step S207, and the FTL 1110 may process the interrupt event again at step S207. When it is determined that the elapsed time T reaches a time point between the timeout critical time Tth1 and the end of the read timeout threshold time Tth2 (“Y” at step S209), the FTL 1110 may temporarily suspend the processing of the interrupt event at step S211. Then, the FTL 1110 may output sub unit data to the host device, the sub unit data corresponding to at least some pieces of the unit data (i.e., a part of the read data) buffered in the buffer memory 130, at step S213.

Therefore, while processing the interrupt event over the read request, the FTL 1110 can respond to the read request of the host device, thereby preventing a timeout error.

The FTL 1110 may check whether the processing of the interrupt event is completed, at step S215. When the processing of the interrupt event is completed (“Y” at step S215), the FTL 1110 may complete the processing of the read request by providing remaining pieces of the read data read from the storage 120 to the host device through the buffer memory 130 at step S217.

When the processing of the interrupt event is not completed (“N” at step S215), the FTL 1110 may check whether the sub unit data buffered at step S205 remains, at step S219. When the buffered sub unit data remains (“Y” at step S219), the FTL 1110 may process the interrupt event at step S207. On the other hand, when the buffered unit data do not remain (“N” at step S219), the procedure may return to step S205. That is, when the read timeout threshold time is completely consumed a plurality of times while the interrupt event is processed, the sub unit data may be outputted a plurality of times. In this case, no more unit data may remain in the buffer memory 130. Therefore, when all of the sub unit data are outputted before the processing of the interrupt event is completed, the processing of the interrupt event may be temporarily suspended, and another sub unit data may be buffered to provide against a timeout.

In the present embodiment, the point of time that the processing of the interrupt event is temporarily suspended to output sub unit data may be between sub operations of the interrupt event. That is, the interrupt event may be a group of a plurality of sub operations Sub OPs, After one sub operation is completed, the processing of the interrupt event may be temporarily suspended to output sub unit data for preventing a timeout.

For example, the garbage collection operation may include a group of a first sub operation of retrieving valid data of source blocks, a second sub operation of selecting a free block to collect the data of the source blocks, and a third sub operation of updating map data.

When each of the sub operations is suspended during the processing of the interrupt event, the procedure may return to the beginning of that suspended sub operation or the interrupt event in the case where the processing is resumed afterwards. In this case, the performance of the data storage device 10 may be degraded. Therefore, after a specific sub operation of the interrupt event is completed, the operation may be temporarily suspended, and sub unit data for preventing a timeout may be outputted. Then, when the processing of the interrupt event is resumed from the next sub operation, the same operation can be prevented from being unnecessarily repeated.

FIG. 7 is a timing diagram for describing the operation method of the data storage device in accordance with the present embodiment.

Referring to FIG. 7, an interrupt event including a plurality of sub operations Sub OP.1 to Sub OP.m may be processed while an interrupt enable signal INTR_EN is enabled after a host read request.

Sub unit data SD11 to SD13, which are at least some pieces of unit data buffered in advance to prevent a read timeout, may start to be outputted between the respective sub operations of the interrupt event, before the read timeout threshold time Tth2 is completely consumed.

As a result, when an interrupt event occurs before the read request of the host device is completed, at least some pieces of the read data buffered in the buffer memory 130 may be outputted to the host device while the interrupt event is processed. Therefore, it is possible to prevent an occurrence of timeout error while an internal operation with a higher priority is processed.

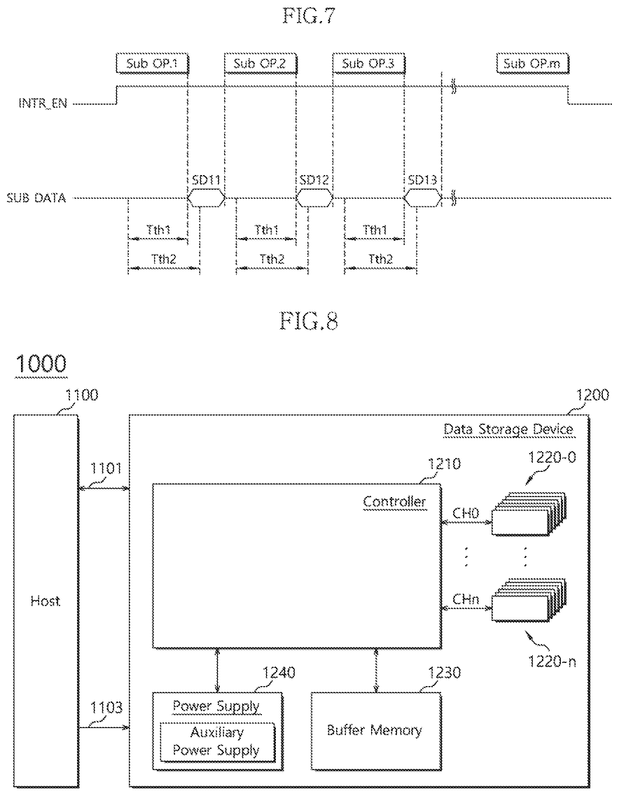

FIG. 8 is a diagram illustrating a data storage system in accordance with an embodiment.

Referring to FIG. 8, the data storage 1000 may include a host device 1100 and the data storage device 1200. In an embodiment, the data storage device 1200 may be configured to a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface device, a control device, a random access memory used as a working memory, an error correction code (ECC) unit, and a memory interface device. In an embodiment, the controller 1210 may configured by controller 110 as shown is FIG. 1 to FIG. 3.

The host device 1100 may exchange a signal with the data storage device 1200 through the signal connector 1101. The signal may include a command, an address, data, and so forth.

The controller 1210 may analyze and process the signal received from the host device 1100. The controller 1210 may control operations of internal function blocks according to a firmware or a software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH1 to CHn, respectively. One or more nonvolatile memory devices may be coupled to one channel. The nonvolatile memory devices coupled to each channel may be coupled to the same signal bus and data bus.

The power supply 1240 may provide power inputted through the power connector 1103, to the inside of the data storage device 1200. The power supply 1240 may include an auxiliary power supply. The auxiliary power supply may supply power to allow the data storage device 1200 to be normally terminated when a sudden power-off occurs. The auxiliary power supply may include large capacity capacitors.

The signal connector 1101 may be configured by various types of connectors depending on an interface scheme between the host device 1100 and the data storage device 1200.

The power connector 1103 may be configured by various types of connectors depending on a power supply scheme of the host device 1100.

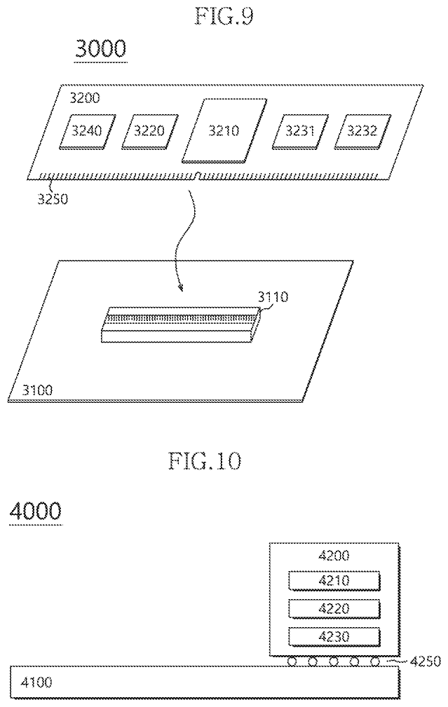

FIG. 9 is a diagram illustrating a data processing system in accordance with an embodiment. Referring to FIG. 9, the data processing system 3000 may include a host device 3100 and the memory system 3200.

The host device 3100 may be configured in the form of a board such as a printed circuit board. Although not shown, the host device 3100 may include internal function blocks for performing the function of a host device.

The host device 3100 may include a connection terminal 3110 such as a socket, a slot or a connector. The memory system 3200 may be mounted to the connection terminal 3110.

The memory system 3200 may be configured in the form of a board such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller as shown in FIGS. 1 to 3.

The buffer memory device 3220 may temporarily store data to be stored in the nonvolatile memory devices 3231 and 3232. Further, the buffer memory device 3220 may temporarily store the data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250, to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data and so forth and power may be transferred between the host device 3100 and the memory system 3200. The connection terminal 3250 may be configured into various types depending on an interface scheme between the host device 3100 and the memory system 3200. The connection terminal 3250 may be disposed on any one side of the memory system 3200.

FIG. 10 is a diagrams illustrating a data processing system in accordance with an embodiment. Referring to FIG. 10, the data processing system 4000 may include a host device 4100 and the memory system 4200.

The host device 4100 may be configured in the form of a board such as a printed circuit board. Although not shown, the host device 4100 may include internal function blocks for performing the function of a host device.

The memory system 4200 may be configured in the form of a surface-mounting type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 as shown in FIGS. 1 to 3.

The buffer memory device 4220 may temporarily store data to be stored in the nonvolatile memory device 4230. Further, the buffer memory device 4220 may temporarily store the data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

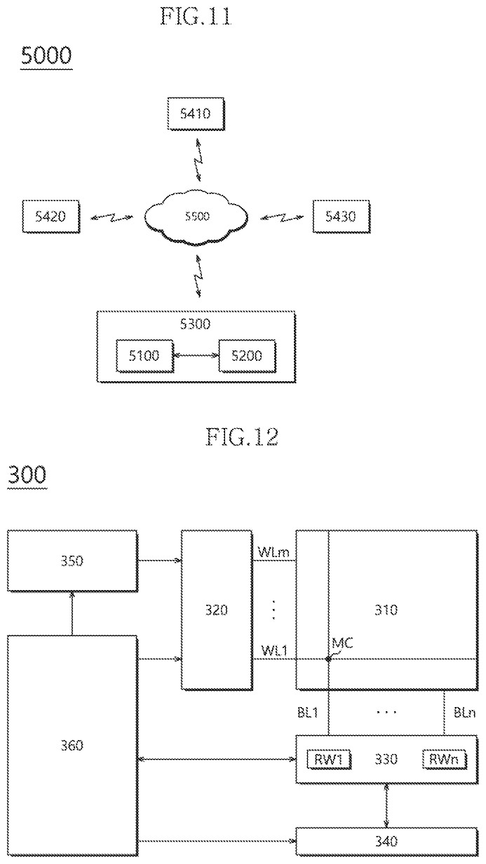

FIG. 11 is a diagram illustrating a network system including a data storage device in accordance with an embodiment. Referring to FIG. 11, the network system 5000 may include a server system 5300 and a plurality of client systems 5410 to 5430 which are coupled through a network 5500.

The server system 5300 may service data in response to requests from the plurality of client systems 5410 to 5430. For example, the server system 5300 may store the data provided from the plurality of client systems 5410 to 5430. For another example, the server system 5300 may provide data to the plurality of client systems 5410 to 5430.

The server system 5300 may include a host device 5100 and the memory system 5200. The memory system 5200 may be configured by the memory system 10 shown in FIG. 1, the data storage device 1200 shown in FIG. 8, the memory system 3200 shown in FIG. 9 or the memory system 4200 shown in FIG. 10.

FIG. 12 is a block diagram illustrating a nonvolatile memory device included in a data storage device in accordance with an embodiment. Referring to FIG. 12, the nonvolatile memory device 300 may include a memory cell array 310, a row decoder 320, a data read/write block 330, a column decoder 340, a voltage generator 350, and a control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array has a direction perpendicular to the flat surface of a semiconductor substrate. Moreover, the three-dimensional memory array means a structure including NAND strings which at least memory cell is located in a vertical upper portion of the other memory cell.

The structure of the three-dimensional memory array is not limited thereto. It is apparent that the memory array structure can be selectively applied to a memory array structure formed in a highly integrated manner with horizontal directionality as well as vertical directionality.

The row decoder 320 may be coupled with the memory cell array 310 through the word lines WL1 to WLm. The row decoder 320 may operate according to control of the control logic 360. The row decoder 320 may decode an address provided from an external device (not shown). The row decoder 320 may select and drive the word lines WL1 to WLm, based on a decoding result. For instance, the row decoder 320 may provide a word line voltage provided from the voltage generator 350, to the word lines WL1 to WLm.

The data read/write block 330 may be coupled with the memory cell array 310 through the bit lines BL1 to BLn. The data read/write block 330 may include read/write circuits RW1 to RWn respectively corresponding to the bit lines BL1 to BLn. The data read/write block 330 may operate according to control of the control logic 360. The data read/write block 330 may operate as a write driver or a sense amplifier according to an operation mode. For example, the data read/write block 330 may operate as a write driver which stores data provided from the external device, in the memory cell array 310 in a write operation. For another example, the data read/write block 330 may operate as a sense amplifier which reads out data from the memory cell array 310 in a read operation.

The column decoder 340 may operate according to control of the control logic 360. The column decoder 340 may decode an address provided from the external device. The column decoder 340 may couple the read/write circuits RW1 to RWn of the data read/write block 330 respectively corresponding to the bit lines BL1 to BLn with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed.

The control logic 360 may control general operations of the nonvolatile memory device 300, based on control signals provided from the external device. For example, the control logic 360 may control operations of the nonvolatile memory device 300 such as read, write and erase operations of the nonvolatile memory device 300.

While various embodiments have been described above, it will be understood to those skilled in the art that the embodiments described are examples only. Accordingly, the data storage device, the operating method thereof and the storage system including the same described herein should not be limited based on the described embodiments.

While various embodiments have been described above, it will be understood to those skilled in the art that the embodiments described are examples only. Accordingly, the operating method of a data storage device described herein should not be limited based on the described embodiments.

What is claimed is:

1. A data storage device comprising:
a storage; and
a controller configured to control data input/output on the storage according to a request transferred from a host device, and provide at least some of read data to the host device before a preset read timeout threshold time is completely consumed, when an interrupt event occurs before a processing of a read request of the host device is completed.

2. The data storage device according to claim 1, wherein the controller provides at least some of the read data independently of processing of the interrupt event, without suspending the processing of the interrupt event.

3. The data storage device according to claim 1, wherein the controller provides the at least some of the read data to the host device while the processing of the interrupt event is temporarily suspended, and resumes the processing of the interrupt event.

4. The data storage device according to claim 3, wherein the interrupt event comprises a group of a plurality of sub operations, and the controller temporarily suspends the processing of the interrupt event between completion of one or more among the sub operations.

5. The data storage device according to claim 1, wherein the interrupt event comprises a background operation.

6. A data storage device comprising:
a storage; and
a controller configured to control data input/output on the storage according to a request transferred from a host device, and provide some of data read in response to a read request of the host device to the host device while a background operation is processed.

7. The data storage device according to claim 6, wherein the controller provides some of the read data independently of the processing of the background operation, without suspending the processing of the background operation.

8. The data storage device according to claim 6, wherein the controller provides the some of the read data to the host device while the processing of the background operation is temporarily suspended, and resumes the processing of the background operation.

9. A data storage device comprising:
a storage; and
a controller configured to control data input/output on the storage according to a request transferred from a host device, buffer at least some of read data into a buffer memory in response to a read request of the host device, and output at least some of the buffered read data to the host device while an interrupt event is processed, when the interrupt event occurs before a processing of the read request of the host device is completed.

10. The data storage device according to claim 9, wherein the controller provides the at least some of the read data independently of the processing of the interrupt event, without suspending the processing of the interrupt event.

11. The data storage device according to claim 9, wherein the controller provides the at least some of the read data to the host device while the processing of the interrupt event is temporarily suspended, and resumes the processing of the interrupt event.

12. The data storage device according to claim 9, wherein the controller provides the at least some of the read data to the host device before a preset read timeout threshold time is completely consumed.

13. An operation method of a data storage device which includes a storage and a controller configured to control data input/output on the storage according to a request transferred from a host device, the operation method comprising:
receiving, by the controller, a read request from the host device, and reading data;
recognizing an occurrence of interrupt event, before the reading of data is completed; and
providing at least some of the read data to the host device before a preset read timeout threshold time is completely consumed.

14. The operation method according to claim 13, wherein the providing of at least some of the read data comprises providing the at least some of the read data independently of processing of the interrupt event, without suspending the processing of the interrupt event.

15. The operation method according to claim 13, wherein the providing of at least some of the read data comprises:
providing the at least some of the read data to the host device, while temporarily suspending the processing of the interrupt event; and
resuming the processing of the interrupt event.

16. The operation method according to claim 15,
wherein the interrupt event comprises a group of a plurality of sub operations, and
wherein the temporarily suspending of the processing of the interrupt event comprises temporarily suspending the processing of the interrupt event between completion of one or more among the sub operations.

17. A storage system comprising:
a host device; and
a data storage device comprising a storage and a controller configured to control data input/output on the storage according to a request transferred from the host device,
wherein when an interrupt event occurs before a processing of a read request of the host device is completed, the controller provides at least some of read data to the host before a preset read timeout threshold time is completely consumed.

18. The storage system according to claim 17, wherein the controller provides the at least some of the read data independently of processing of the interrupt event, without suspending the processing of the interrupt event.

19. The storage system according to claim 17, wherein the controller provides the at least some of the read data to the host device while the processing of the interrupt event is temporarily suspended, and resumes the processing of the interrupt event.

20. The storage system according to claim 19, wherein the interrupt event comprises a group of a plurality of sub operations, and the controller temporarily suspends the processing of the interrupt event between completion of one or more among the sub operations.

21. A data storage device comprising:
a storage; and
a controller configured to output, to a host in response to a request of the host, at least a piece of so far read data within a read timeout duration while processing an interrupt event and suspending a read operation related to the so far read data.
